(19) United States
(12) Patent Application Publication
(10) Pub. No.: US 2011/0317832 A1
(43) Pub. Date: Dec. 29, 2011

(54) Dynamic Image Reproduction Code Generation Device, Dynamic Image Distribution System, Execution Format Program, Recording Medium Containing The Program, Server, And Dynamic Image Reproduction Code Generation Method

(75) Inventor: Koji Ohno, Tokyo (JP)

(73) Assignee: VISIONCARE CORPORATION, Tokyo (JP)

(21) Appl. No.: 13/142,203

(22) PCT Filed: Dec. 22, 2009
(86) PCT No.: PCT/JP2009/007144

§ 371 Date: Sep. 15, 2011

(30) Foreign Application Priority Data
Dec. 26, 2008 (JP) 2008-334607

(51) Int. Cl. H04N 7/167; H04N 5/913; H04N 9/80

(52) U.S. Cl. 380/201; 386/240; 386/E05.004

(57) ABSTRACT

A video reproduction code generation device has: a data acquisition unit which acquires video data; a code acquisition unit which acquires video reproduction template code configured to enable reproduction of video data stored in a variable in code; and a code generation unit, which divides the acquired video data into two or more data parts, embeds the data parts into the acquired video reproduction template code as variable values of different variables, and generates dedicated video reproduction code for the acquired video data.

### TECHNICAL FIELD

This invention relates to technology of video reproduction code and program in which is embedded video data.

### BACKGROUND ART

In recent years the delivery and public release of video via the Internet has become popular, and this has been accompanied by increasing interest in services which bill users viewing such delivered and publicly released videos, so that a framework for this purpose has become necessary.

In such video delivery and public release services of the prior art, in order to reproduce a downloaded video or a video reproduced by streaming, a method has generally be used in which dedicated client software is installed on a PC terminal and the video is viewed.

### DISCLOSURE OF THE INVENTION

### Problems to be Solved by the Invention

However, the method of installing dedicated client software on a PC terminal for viewing has the problem that users lose interest due to the trouble involved in installation. Further, when the video compression format is modified, or when the billing method is modified, or when the DRM (Digital Rights Management) has been hacked or similar, the need arises for client software updating, and there is the problem that users are burdened with maintenance tasks.

This invention has as a principal object the resolution of the above problems of the prior art, and provides a video reproduction code generation device, video delivery system, executable program, recording medium on which is recorded such a program, server, and video reproduction code generation method.

### Means for Solving the Problems

In order to resolve these problems, this invention adopts the following means.

That is, a video reproduction code generation device of this invention comprises a data acquisition unit which acquires video data; a code acquisition unit which acquires video reproduction template code, configured to enable reproduction of video data stored in a variable in code; and a code generation unit, which divides the acquired video data into two or more data parts, embeds the data parts into the acquired video reproduction template code as variable values of the different variables, and generates dedicated video reproduction code for the acquired video data.

By means of this configuration, video reproduction code into which video data has been embedded can be generated, and by means of this video reproduction code, there is no longer a need for a user to install dedicated client software when reproducing the video. Further, the user is spared the trouble of updating client software.

It is preferable that the video data stored in the variable be encrypted video data, and that the video reproduction template code have decoding code which acquires encrypted video data in reference to the variable and decodes the acquired encrypted video data, and reproduction code which reproduces the decoded video data.

It is preferable that the encrypted video data require a decryption key for decoding, and that the video reproduction template code further have decryption key acquisition code which acquires a decryption key, which is used in decoding the encrypted video data, from a decryption key storage unit.

It is preferable that the video reproduction template code further have authentication code which transmits an authentication request to an authentication response unit, and receives an authentication result.

It is preferable that the video reproduction template code further have billing code which performs fee payment processing to a billing response unit for authentication.

It is preferable that the video reproduction template code further have distributor information transmission code, which transmits distributor information specifying a distributor of the video data, to a distributor information management unit.

It is preferable that the encrypted video data have a first encrypted portion encrypted using a first encryption method and a second encrypted portion encrypted using a second encryption method, and that the decoding code further acquire, from a decoding information storage unit, decoding information necessary to decode the first encrypted portion and the second encrypted portion.

It is preferable that the encrypted video data be encrypted only in a specific range of a specific frame of the video, and that the decoding code acquire, from the decoding information storage unit, decoding information including the specific frame and specific range information for decoding of the encrypted video data.

It is preferable that the video data be omitted in a specific range of video data, and that the video reproduction template code further include omitted data acquisition code which acquires, from an omitted data storage unit, omitted data information indicating the specific range of omitted data, and the omitted data.

It is preferable that dummy data be inserted into the video data in a specific range of the video, and that the video reproduction template code further have supplemental video acquisition code which acquires, from a supplemental data storage unit, dummy data information indicating the specific range of the dummy data and supplemental video data to be interchanged with the dummy data.

It is preferable that the reproduction order of the acquired video data be interchanged, and that the video reproduction template code further have reproduction order acquisition code which acquires, from a reproduction order storage unit, information indicating the correct reproduction order of the video data the reproduction order of which has been interchanged.

It is preferable that the video data be encrypted only in a specific range of the video, and that the video reproduction template code further have encrypted portion transmission/reception code which transmits the encrypted portion of the encrypted video data to the video decoding unit, and receives the decoded video data.

Further, a video delivery system of this invention has the video reproduction code generation device according to any of Claims 1 to 12, an execution file generation unit which compiles the generated video reproduction code and generates an execution file, and a delivery unit which delivers the created execution file to a user terminal via a communication network.

Further, an executable program of this invention, which is a dedicated program for reproduction of specific video data stored in a variable in the program, holds data parts, obtained by dividing the specific video data into two or more parts, as variable values of the different variables.

It is preferable that the specific video data is encrypted video data obtained by encryption, and that a decoding module function to decode the encrypted video data is further provided.

It is preferable that recording media on which the executable program is recorded be provided.

Further, a server of this invention to support the reproduction of encrypted video data has a decoding information transmission module having a decoding information table which manages decoding information necessary to perform decoding of encrypted video data, and is characterized in that the decoding information transmission module transmits decoding information to a terminal which is attempting to reproduce encrypted video data, in response to a request from the terminal.

Further, a video reproduction code generation method of this invention has a data acquisition step of acquiring video data; a code acquisition step of acquiring video reproduction template code, configured to enable reproduction of video data stored in a variable in the code; and a code generation step of dividing the acquired video code into two or more data parts, embedding the data parts into the acquired video reproduction template code as variable values of the different variables, and generating dedicated video reproduction code for the acquired video data.

It is preferable that the video data stored in the variable be encrypted video data, and that the video reproduction template code have decoding code which acquires the encrypted video data referencing the variable and decodes the acquired encrypted video data, and reproduction code which reproduces the decoded video data.

In this application, “code” refers to a source program prior to compiling, and “executable program” refers to a program in a form that can be executed by a PC terminal or similar, generated by compiling a source program. By executing the executable program using a PC terminal or similar, prescribed functions can be realized. In this application, means of such realized functions are called “modules”. In addition, “code” also includes a source program in an interpretive language, in which case compiling is not necessary.

To “embed” means to incorporate data into code so as to be made integral with the code.

Each of the processes in an information processing method of this invention can be executed by a CPU in a server or terminal according to a program. This program can be installed or loaded onto a server or video reproduction device from a CD-ROM, magnetic disk, semiconductor memory, or various other kinds of recording medium, or can be downloaded via a communication network.

In this Specification, “unit” does not refer only to physical means, but also includes the realization by software of functions of the unit. Further, a functions of a single unit may be realized by two or more physical means, and a function of two or more units may be realized by a single physical means.

### Advantage of the Invention

By means of this invention, a video reproduction code generation device, video delivery system, executable program, recording medium on which is recorded the same program, server, and video reproduction code generation method can be provided, and the advantageous results of eliminating the need for installation of dedicated client software when a user reproduces video, and of eliminating the burden on the user of updating client software, are obtained.

### DESCRIPTION OF THE DRAWINGS

FIG. 1 shows the configuration of a video delivery system;

FIG. 2A shows the configuration of video reproduction template code;

FIG. 2B shows the configuration of video reproduction code;

FIG. 3A shows an example of video reproduction template code prior to embedding of video data;

FIG. 3B shows an example of video reproduction code after embedding of video data;

FIG. 4 shows the configuration of a video player in a user terminal and a response unit in a server;

FIG. 5 shows a first specific example of encrypted video data;

FIG. 6 shows a configuration to decode encrypted video data;

FIG. 7 shows a second specific example of encrypted video data;

FIG. 8 shows video data with the data in a specific range omitted;

FIG. 9 shows a configuration to generate video data from which data in a specific range has been omitted;

FIG. 10 shows video data with dummy data inserted;

FIG. 11 shows a configuration to reproduce video data with dummy data inserted;

FIG. 12 shows video data with the reproduction order interchanged;

FIG. 13 shows a configuration to reproduce video data with the reproduction order interchanged; and

FIG. 14 shows a configuration to decode encrypted video data in a server.

### BEST MODES FOR CARRYING OUT THE INVENTION

Embodiments of this invention, and specific examples of encryption methods and similar, are explained referring to the drawings. However, the following embodiments are merely exemplifications of the invention, and do not limit the technical scope of the invention. In the drawings, the same symbols are assigned to the same units.

### Embodiments of the Invention

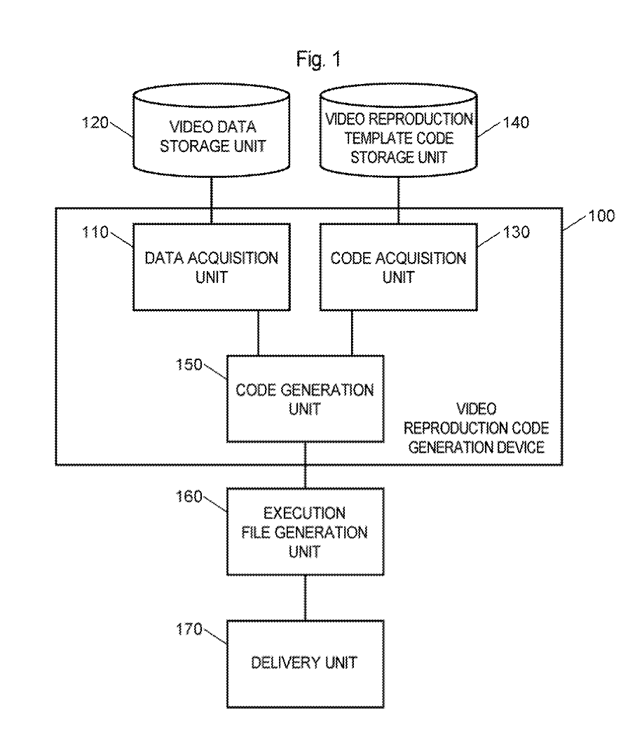

### FIG. 1

First, a specific example is used to explain an embodiment of the invention, referring to FIG. 1 to FIG. 4.

FIG. 1 shows the configuration of a video delivery system of this embodiment. The video delivery system of this embodiment comprises a data acquisition unit 110, video data storage unit 120, code acquisition unit 130, video reproduction template code storage unit 140, code generation unit 150, execution file generation unit 160, and delivery unit 170. The data acquisition unit 110, code acquisition unit 130, and code generation unit 150 form a video reproduction code generation device 100.

(Data Acquisition Unit 110)

The data acquisition unit 110 issues a request to the video data storage unit 120 and acquires encrypted video data, and transmits the acquired video data to the code generation unit 150. The data acquisition unit 110 need not necessarily receive encrypted video data from the video data storage unit 120, and after reception of initially unencrypted video data from the video data storage unit 120, may acquire video data which has been encrypted by encryption processing of this data acquisition unit 110. In this case, the data acquisition unit 110 further has a function for encrypting video data.

(Video Data Storage Unit 120)

The video data storage unit 120 stores already-encrypted video data, and transmits video data to the data acquisition unit 110 in response to a request from the data acquisition unit 110. As explained above, when performing encryption in the video acquisition unit 110, the video data storage unit 120 stores unencrypted video data, and transmits unencrypted video data to the data acquisition unit 110.

(Code Acquisition Unit 130)

The code acquisition unit 130 issues requests to the video reproduction template code storage unit 140 and acquires video reproduction template code, and transmits the acquired video reproduction template code to the code generation unit 150.

(Video Reproduction Template Code Storage Unit 140)

The video reproduction template code storage unit 140 stores video reproduction temperature code, and in response to a request from the code acquisition unit 130, transmits the video reproduction template code. The video reproduction template code is configured so as to be able to store video data in a local variable within the code, and so as to be able to reproduce the video data referencing the local variable. Further, the video reproduction template code comprises a number of code portions; these are explained below, together with an explanation of the configuration of the video reproduction code.

In order to prevent illicit extraction and reproduction by a third party of video data embedded in code, it is desirable that the video data be held as a variable value of a local variable which is integral with and inseparable from the code. However, the variable may be a global variable or may have some other format, in which cases a constant advantageous result is obtained.

(Code Generation Unit 150)

The code generation unit 150 acquires video data from the data acquisition unit 110, and acquires video reproduction template code from the code acquisition unit 130. The code generation unit 150 further divides acquired video data into two or more data parts, embeds each of the data parts as a variable value of a different variable within the video reproduction template code, and generates dedicated video reproduction code for the video data. Further, the code generation unit 150 transmits the generated video reproduction code to the execution file generation unit 160. Details of this embedding operation are explained below, together with an explanation of the configuration of the video reproduction code.

(Execution File Generation Unit 160)

The execution file generation unit 160 acquires and compiles video reproduction code generated by the code generation unit 150, and generates an executable program. The executable program may have the format of the extension exe of general execution files, or may be in any format which can be executed by a PC terminal or similar.

By employing such a compiled executable program, the program can be executed by the user, who can easily view the video data included in the program. Further, by compiling, the code prior to compiling can be made difficult to read, and by rendering difficult analysis by illicit users, illicit viewing of the video data can also be prevented.

(Delivery Unit 170)

The delivery unit 170 delivers the executable program generated by the execution file generation unit 160, via a communication network (not shown), to the terminal of a user desiring to view the video data included in the executable program. User terminals may be PC terminals or similar, and in addition to portable terminals, include all equipment capable of enabling video viewing.

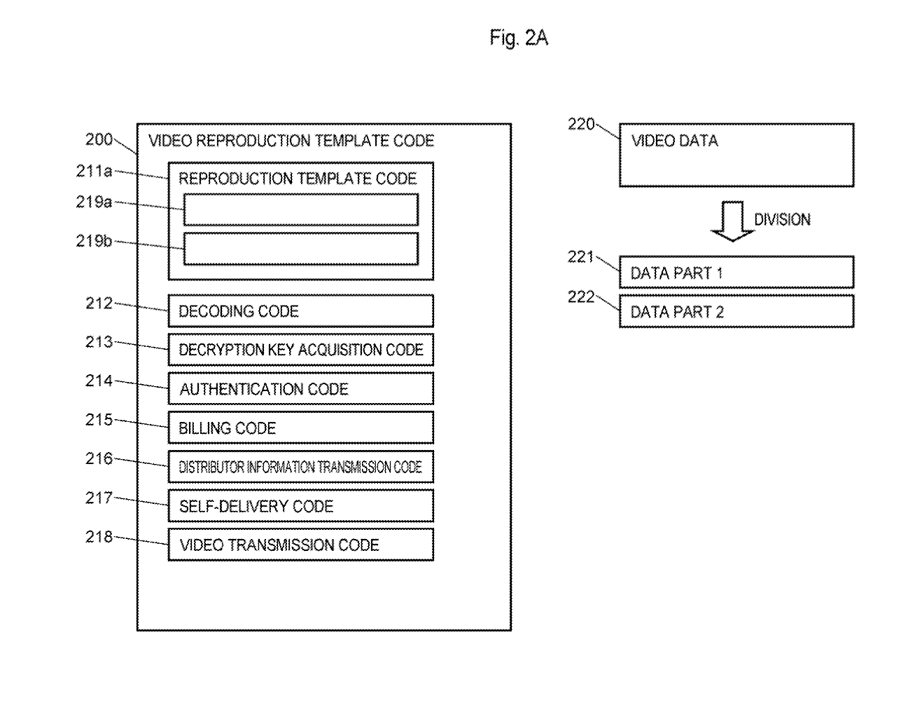

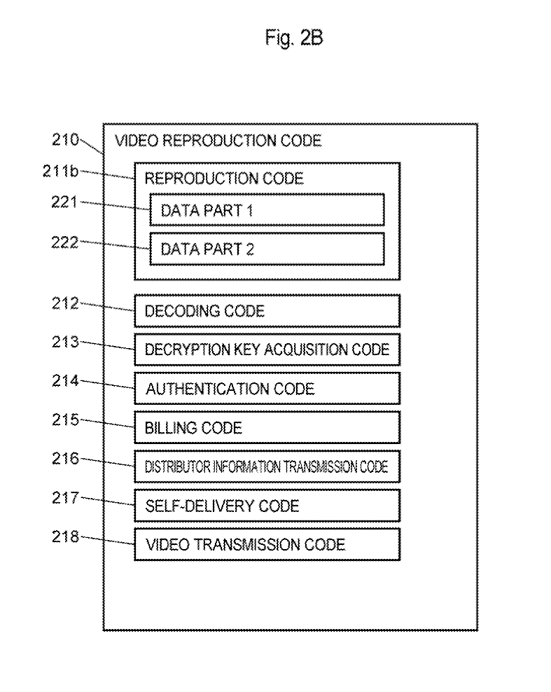

(FIG. 2)

Next, the configuration of video reproduction code is explained, referring to FIG. 2A and FIG. 2B. The video reproduction template code 200 of this embodiment comprises reproduction template code 211a, decoding code 212, decryption key acquisition code 213, authentication code 214, billing code 215, distributor information transmission code 216, self-delivery code 217, and video transmission code 218. The reproduction template code 211a within the video reproduction template code 200 is configured so as to be able to embed data parts, obtained by dividing video data into a plurality of parts, into it as variable values of different variables. In this embodiment, the code generation unit 150 acquires the video data 220, and as shown in FIG. 2A, divides this into a data part 1 (221) and a data part 2 (222). On the other hand, in the reproduction template code 211a acquired by the code generation unit 150, two variables, variable 1 (219a) and variable 2 (219b), are prepared in advance so as to embed the two data parts which are data part 1 (221) and data part 2 (222). The code generation unit 150, by embedding the data part 1 (221) and data part 2 (222) in variable 1 (219a) and variable 2 (219b) prepared in advance in the reproduction template code 211a, generates video reproduction code 210 comprising the reproduction code 211b shown in FIG. 2B.

Each of the code parts explained here has prescribed functions, and after compiling, by execution on a PC terminal or similar, functions are realized as the respective corresponding modules, and the video data 220 can be reproduced. The functions of each of the code parts are explained below as functions of the corresponding modules.

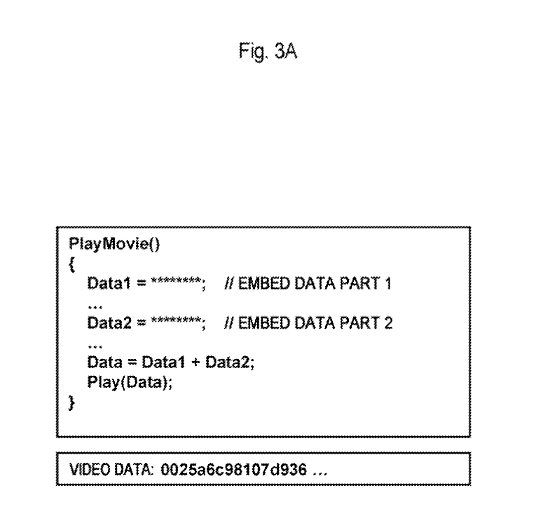

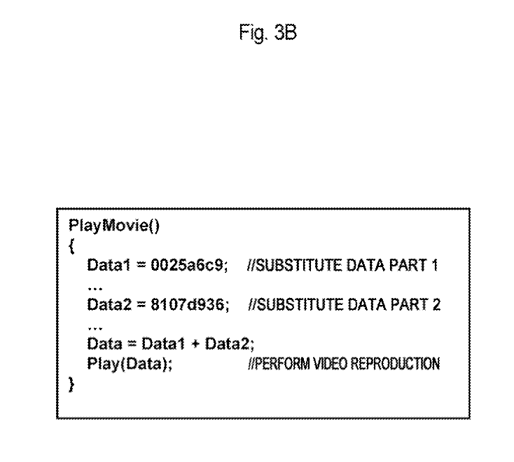

(FIG. 3)

Next, in reference to FIGS. 3A and 3B, a specific explanation is given of embedding of data part 1 (221) and data part 2 (222) in the video reproduction template code, and of generation of video data 220 from the data parts.

FIG. 3A is an example of video reproduction template code 200 prior to embedding of data parts. Here, template code is presented for a “PlayMovie” function, which is the reproduction template code 211a including variables Data1 and Data2 to embed data part 1 and data part 2, and a variable Data to join the data parts, as well as a function Play which functions to reproduce the video data, as code included in the video reproduction template code 200. Video data prior to division is also presented.

FIG. 3B shows reproduction code 211b in which data parts are embedded. As shown in the figure, video data is divided by the code generation unit 150 and embedded in Data1 and Data2. When this “PlayMovie” function code is executed after compiling together with other function code as necessary, the variables Data1 and Data2 corresponding to data part 1 and data part 2 are referenced, Data is obtained as the joined video data, and the video data is reproduced by the Play function.

In this embodiment, an example of embedding all data parts in the code was explained for the case of the “PlayMovie” function, which is the reproduction code; but other configurations are possible. That is, data parts need not necessarily be embedded within a single function code part, and may be dispersed and embedded within all parts of the video reproduction template code 200. Further, each of the above-described code parts, including reproduction code, need not necessarily be described as mutually independent function code parts, but may be combined to form a single function code part. Conversely, the above-described code parts having the prescribed functions may be configured by combining a plurality of function code parts.

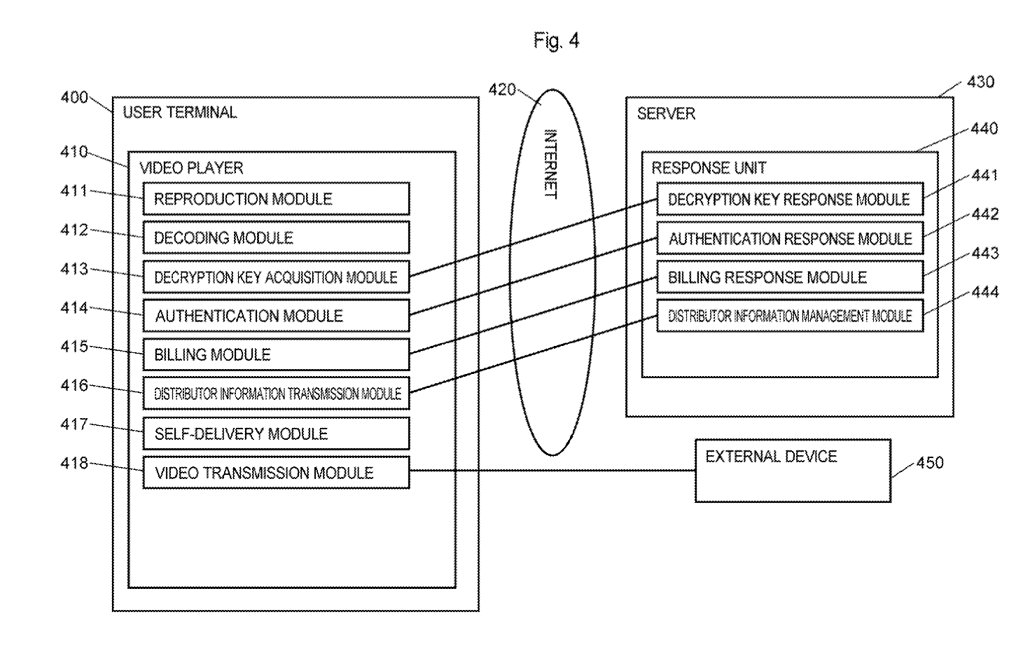

(FIG. 4)

Next, FIG. 4 is used to explain operation when, after the video reproduction code 210 is compiled by the execution file generation unit 160 and the compiled execution file is delivered by the delivery unit 170, the file is executed on a user terminal. That is, when the video reproduction code 210 of FIG. 2 is compiled by the execution file generation unit 160 of FIG. 1, a video player program, which is a dedicated executable program for reproduction of the embedded video, is generated. This video player program is delivered by the delivery unit 170 of FIG. 1 to PC terminals, portable terminals and similar as user terminals, and is executed by the PC terminals and similar.

As shown in FIG. 4, when the video player program is executed in the user terminal 400, a video player 410 is realized on the user terminal 400. The video player 410 comprises a reproduction module 411, decoding module 412, decryption key acquisition module 413, authentication module 414, billing module 415, distributor information transmission module 416, self-delivery module 417, and video transmission module 418. On the other hand, the server 430 comprises a response unit 440, and the response unit 440 comprises a decryption key response module 441, authentication response module 442, billing response module 443, and distributor information management module 444. This server 430 is connected to the user terminal 400 via the Internet 420. Functionally, the decryption key acquisition module 413 exchanges information with the decryption key response module 441, the authentication module 414 exchanges information with the authentication response module 442, the billing module 415 exchanges information with the billing response module 443, and the distributor information transmission module 416 exchanges information with the distributor information management module 444. Further, the video transmission module 418 exchanges information with an external device 450.

Each of these modules of the video player realizes prescribed functions corresponding to the respective code.

In the following embodiments, for purposes of simplification an explanation is given for examples in which the decryption key response module 441, authentication response module 442, billing response module 443, and distributor information management module 444 are also comprised by the response unit 440 within the single server 430; but the various modules may each be comprised by separate servers.

(Reproduction Module 411)

The reproduction module 411 is a module which realizes the functions of the reproduction code 211, and reproduces decoded video data. The reproduced video data is displayed on a monitor or similar by means of a display function (not shown).

(Decoding Module 412)

The decoding module 412 is a module which realizes the functions of the decoding code 212, and as shown specifically in FIG. 3B, references the variables corresponding to data part 1 and data part 2 embedded in the video reproduction code 210 to acquire the encrypted video data, and decodes the acquired encrypted video data. That is, video data decoded by the decoding module 412 is acquired by the reproduction module 411, and as explained above the reproduction module 411 performs reproduction.

Here, for simplicity an example is presented in which the video data is divided into two parts, which are data part 1 and data part 2; but the video data need not necessarily be divided into two parts, and can be divided into an arbitrary number of two or more parts.

When the video data is not encrypted, among these functions, the function of referencing variables and acquiring encrypted video data is present in the above-described reproduction module 411.

By providing the two modules which are the above-described reproduction module 411 and the decoding module 412, the video player 410 can reproduce encrypted video data. Further, the video player 410 can be realized by executing an executable program for video reproduction, and the video reproduction software and video data are distributed to users in an integrated manner, so that when distributing new video data it is possible to distribute the newest video reproduction software linked thereto, and on the user's side there is the advantageous result that the trouble of updating and other maintenance of the video reproduction software is eliminated.

(Decryption Key Acquisition Module 413)

The decryption key acquisition module 413 is a module which realizes the functions of the decryption key acquisition code 213, and in order to acquire a decryption key for use in decoding encrypted video data from the decryption key response module 441 within the server 430 functioning as a decryption key storage unit, issues a decryption key request to the decryption key response module 441. The decryption key response module 441 transmits a decryption key for use in decoding encrypted video data to the decryption key acquisition module 413 in response to the request from the decryption key acquisition module.

By causing the decryption key to be acquired from the server 430 and used for decoding in this way, it is difficult for an illicit user to obtain the decryption key, and thus illicit users can be impeded from analyzing the video player 430 distributed to a user, decoding the data, and reproducing the video data included in the video player 430.

Here, an example was explained in which, as the decryption key storage unit, the decryption key response module 441 is within the server 430; but the decryption key response module 441 may be realized outside the server 430, by a program or similar recorded in USB memory, on an optical disc, on a magnetic disk, or on another recording medium. Whereas when the decryption key response module 441 is disposed within the server 430 there is the advantageous result that the modules can be managed in one place, or in a comparatively small number of places, when the a program realizing the decryption key response module 441 is recorded in USB memory or on another recording medium, it is more difficult for persons other than authorized users to access the USB memory or similar compared with a server, and viewing of the video by persons other than authorized users can be more effectively suppressed.

(Authentication Module 414)

The authentication module 414 is a module which realizes the functions of the authentication code 214, and transmits an authentication request to the authentication response module 442 within the server 430 functioning as the authentication response unit, and receives an authentication response. The authentication response module 442 receives the authentication request from the authentication module 414, and performs authentication of the authentication requester as an authorized user by means of a user ID and password or similar. The authentication response module 442 is configured such that the decryption key can be transmitted from the above-described decryption key response module 441 to the decryption key acquisition module 413 only in a case where the authentication requester is determined to be an authorized user.

By performing authentication processing between the authentication module 414 and the authentication response module 442 in this way prior to transmission of the decryption key, authentication of the authentication requester as an authorized user can be performed on the server side, and reproduction of the video data by an illicit user not possessing the right to view the video can be prevented.

Authentication by the authentication response module 442 may be performed not only to allow transmission of the decryption key from the decryption key response module 441 to the decryption key acquisition module 413, but also to allow transmission of information from the server 430 by a separate module to the user terminal 400, explained below.

(Billing Module 415)

The billing module 415 is a module which realizes the functions of the billing code 215, and sends necessary user information to the billing response module 443 within the server 430 functioning as the billing response unit in order to perform fee payment processing for authentication. The billing response module 443 can be configured such that the user information is registered in the server 430, and such that, after confirming that appropriate fee payment processing (billing processing) has been performed, or that the user has previously completed fee payment processing (billing processing), the decryption key is transmitted from the above-described decryption key response module 441 to the decryption key acquisition module 413.

By this performance of payment processing (billing processing) prior to transmission of the decryption key, it is made difficult to acquire the decryption key without the performance of billing, and decoding and reproduction of encrypted video data by an illicit user not possessing the right to view the video can be prevented.

Authentication by the billing module 415 may be performed not only to allow transmission of the decryption key from the decryption key response module 441 to the decryption key acquisition module 413, but also to allow transmission of information to the user terminal 400 by a separate module from the server 430, explained below.

(Distributor Information Transmission Module 416)

The distributor information transmission module 416 is a module which realizes the functions of the distributor information transmission code 216, and transmits distributor information, specifying the distributor of the video player program (including the video data), to the distributor information management module 444 within the server 430 which functions as the distributor information management unit. Distributor information is embedded when generating video reproduction code in the code generation unit 150. On the other hand, the distributor information management module 444 within the server 430 stores distributor information received from the distributor information transmission module 416. This distributor information is information indicating by whom the video player program (including video data) was distributed, and by managing such information on a server, for example it is possible to make payment to the distributor, with a portion of the fee billed to the user viewing the video data paid as a margin to the distributor. By this means the distributor can be motivated to use a P2P network, its own server, a recording medium, or similar to distribute the video reproduction code (including the video player).

According to the application, the distributor information can also be made to include, in addition to information relating to the person distributing the video player program, or in place of such information, copyright holder information for the video data, information on the person generating the video reproduction code including the video data, information on the person generating the video player program, or other necessary information on other persons.

(Self-Delivery Module 417)

The self-delivery module 417 is a module which realizes the functions of the self-delivery code 217, and can be put into a state enabling delivery of the video player program (including the video data) using a P2P network. A state enabling delivery can for example be realized by saving the video player program in a for-transmission folder, which is to be referenced in a case in which the terminal itself is referenced from P2P software of another terminal. By this means, by increasing the users to whom this video reproduction player program (including video data) is to be delivered, an advantageous result similar to that of fortifying the server can be obtained, without fortifying the delivery server.

The functions of the self-delivery module 417 can be realized by a self-delivery module included in conventionally existing P2P software or similar.

(Video Transmission Module 418)

The video transmission module 418 is a module which realizes the functions of the video transmission code 218, and performs transmission to an external device 450 in order to cause display of reproduced video, reproduced by the user terminal 400 using the video player 410. The external device 450 is for example a TV set, or a portable terminal or similar. Video reproduced by a PC terminal or similar as the user terminal 400 can be displayed by and viewed on a TV set or portable terminal. Further, the video transmission module 418 can also copy the video data to a portable terminal as the external device 450, after first converting the video data file format into a format which can be reproduced by the portable terminal.

Functions of the video transmission module 418 can be realized by a video transmission module comprised by conventionally existing Bluetooth equipment or similar.

In the above, a specific explanation of an embodiment of the invention has been given. In this embodiment, numerous code parts and modules were explained; but these code parts and modules need not necessarily all be included in the video reproduction code or in the video player, and use in arbitrary combination is also possible, insofar as contradictions do not occur.

(Specific Example of Encryption Method and Similar)

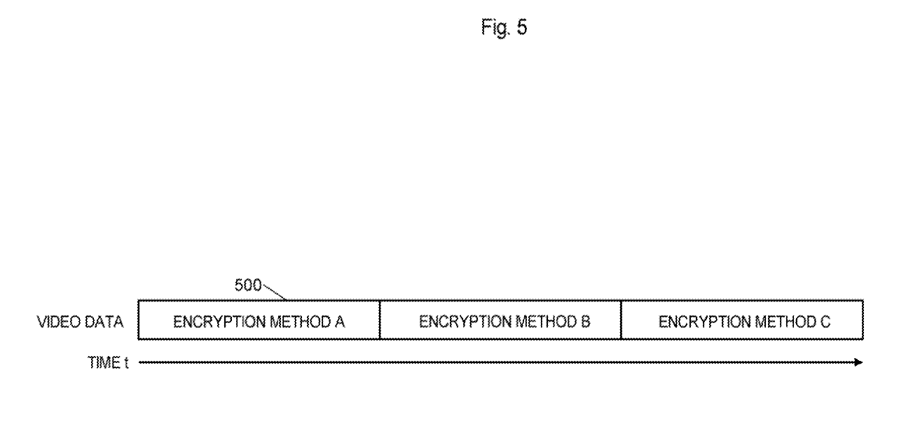

Next, specific examples of encryption methods and similar used in an embodiment of the invention are explained, referring to FIG. 5 to FIG. 14.

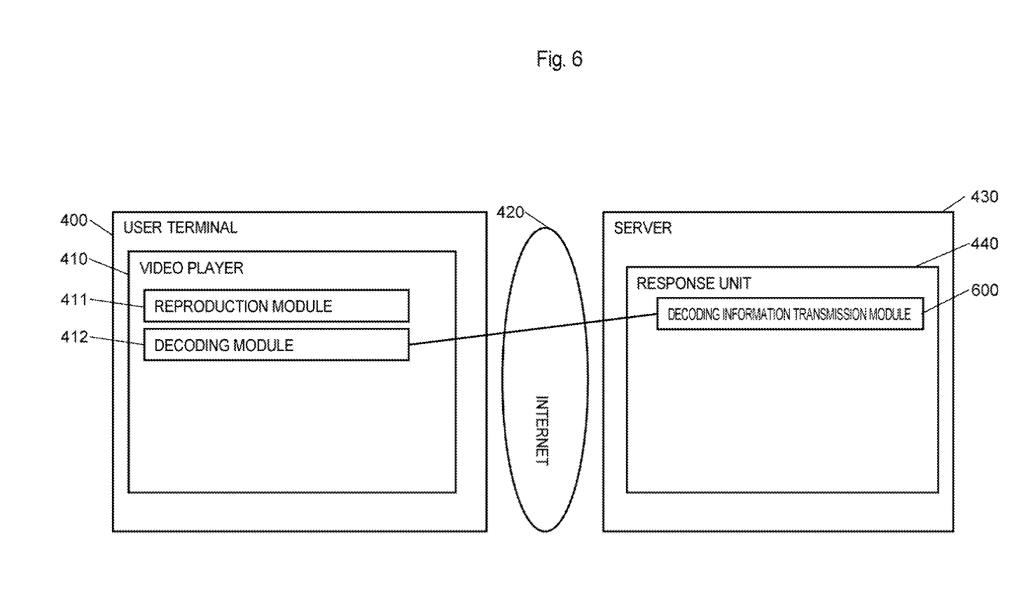

(FIG. 5 and FIG. 6)

First, FIG. 5 and FIG. 6 are Used to Explain a First Specific Example of Encrypted video data, decoded by the decoding module 412. In FIG. 5, 500 indicates encrypted video data. That is, the encrypted video data 500 comprises an encrypted part a, encrypted part b, and encrypted part c, respectively encrypted using three types of encryption which are encryption method A, encryption method B, and encryption method C, according to the time t elapsed. More specifically, the respective encrypted parts are for example obtained by encrypting using encryption method A from 0 seconds to 60 seconds, encrypting using encryption method B from 60 seconds to 120 seconds, and encrypting using encryption method C from 120 seconds to 180 seconds. The times or the frames which are the points at which encryption methods are changed can be set independently of the points at which video data is divided into data part 1 and data part 2, as described above. Further, the ability to set the times or similar used as change points independently of the video data division points is the same for all the encryption methods described below.

FIG. 6 shows a configuration by means of which a video player 410 executed by a user terminal 400 decodes the encrypted video data. The video player 410 comprises a reproduction module 411 and a decoding module 412. The decoding module 412 comprised by the video player 410 issues, via the Internet 420, a request for decoding information to a decoding information transmission module 600 comprised by a response unit 440 of a server 430. The decoding information transmission module 600 has a decoding information table which manages and associates decoding information necessary for the decoding with the distributed video player program, and in response to a request from the decoding module 412, transmits decoding information necessary to decode the encrypted parts a, b and c to the decoding module 412. By this means the decoding module 412 can acquire decoding information necessary for decoding from the decoding information transmission module 600 within the server 430 which functions as the decoding information storage unit. Decoding information necessary for decoding is for example information specifying at what times, or at what frames, which encryption methods are used. Decoding information can further comprise information specifying which decryption keys are to be used; in this case, the video player 410 further comprises the decryption key acquisition module 413 explained using FIG. 4, and the response unit 440 of the server 430 further comprises the decryption key response module 441. The functions of the decryption key acquisition module 413 and decryption key response module 441 are as explained above.

By means of this configuration, because it is difficult to perform decoding without obtaining decoding information, the video player 410 can raise the difficulty of deciphering the encoded video data, and illicit users can be prevented from illicitly viewing the video data.

Here, a method can be employed in which the combination of video data encryption methods and of change points are made different for each video data part for distribution.

By means of this method, because the combinations of encryption methods are different for each distributed video data part, and because numerous such combinations exist, even if the combination pattern of encryption methods for a certain video player were deciphered, it would not be possible to similarly apply the deciphered pattern to another video player to perform deciphering. Hence even if an illicit user were to succeed in extracting video data from a video player, the encryption pattern specific to each extracted video data part could not easily be deciphered, and so there is the advantageous result that protection of the video data embedded in the video player can be strengthened.

Authentication or billing processing can be performed prior to transmission of decoding information by the decoding information transmission module 600; in this case, the video player 410 comprises the authentication module 414 or the billing module 415, and the response unit 440 comprises the corresponding authentication response module 442 or billing response module 443. The functions of these modules are as described above.

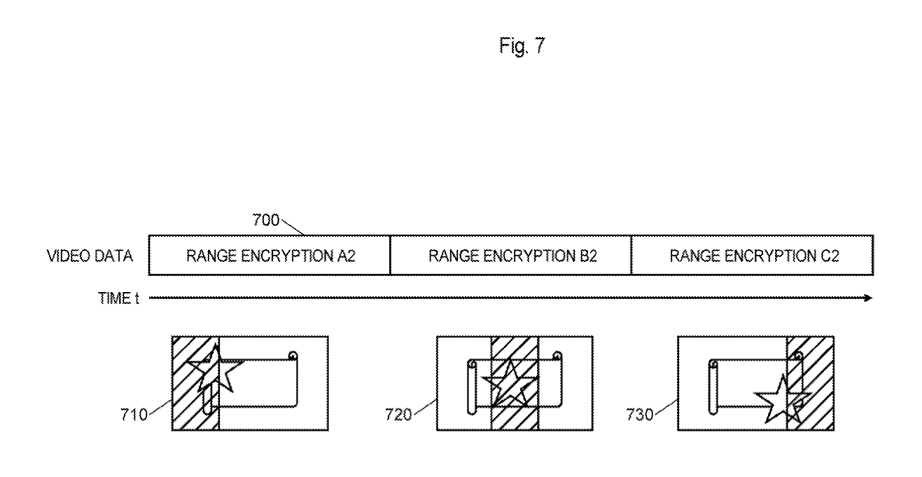

(FIG. 7)

Next, FIG. 7 is used to explain a second specific example of encrypted video data. In FIG. 7, 700 represents encrypted video data. The video data 700 comprises an encrypted part a2, encrypted part b2, and encrypted part c2, respectively encrypted using three types of encryption which are range encryption A2, range encryption B2, and range encryption C2, according to the time t elapsed. Here encryption is performed only for a prescribed range of the video data. More specifically, in the encrypted video data parts 710 to 730, encryption is performed only of the shaded parts, only on the left side in the video data 710, only in the center in the video data 720, and only on the right side in the video data 730. Further, this encryption is applied only to specific frames (for example I frames) inserted into the video data at constant intervals and serving as reference.

Decoding of this encrypted video data is performed by transmission and reception of information between the decoding module 412 and the decoding information transmission module 600, having functions similar to those of FIG. 6. That is, the decoding module 412 can acquire, from the decoding information transmission module 600 within the server 430 functioning as the decoding information storage unit, decoding information comprising specific frames and specific range information for decoding the encrypted video data. The decoding information can further comprise information specifying which decryption key is to be used; in this case, the video player 410 further comprises the decryption key acquisition module 413 explained in FIG. 4, and the response unit 440 of the server 430 further comprises the decryption key response module 441. The functions of the decryption key acquisition module 413 and the decryption key response module 441 are as described above.

By means of this configuration, in addition to the advantageous results of the above-described first specific example, only a portion of the video data is decoded by the video player 410, so that there are the advantageous results that the load on user terminal 400 during processing to decode video data in the video player 410 can be alleviated, and that even a user terminal of comparatively low performance can smoothly reproduce video.

Further, only frames serving as reference are encrypted, so that while alleviating the load during decoding processing as described above, appropriate decoding of the entirety of the video is made impossible, and illicit reproduction can be prevented.

This range encryption need not always be performed only for specific frames serving as reference, but may for example be performed for all frames, or may be performed for 1 frames and P frames; in these cases also, constant advantageous results are obtained. However, when performing encryption only of limited portions, such as only I frames, there is the advantageous result of being able to greatly contribute to alleviating the processing load.

Further, authentication or billing processing can be performed prior to transmission of decoding information by the decoding information transmission module 600; in this case, the video player 410 comprises an authentication module 414 or billing module 415, and the response unit 440 comprises the corresponding authentication response module 442 or billing response module 443. The functions of these modules are as described above.

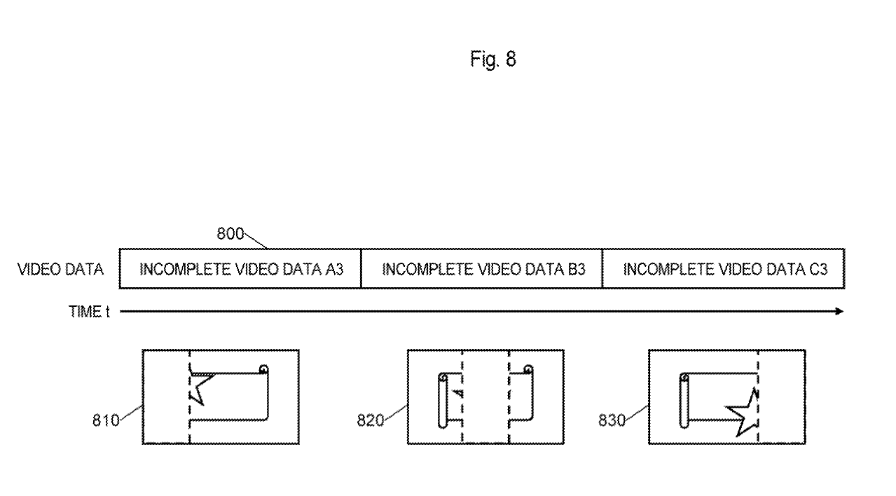

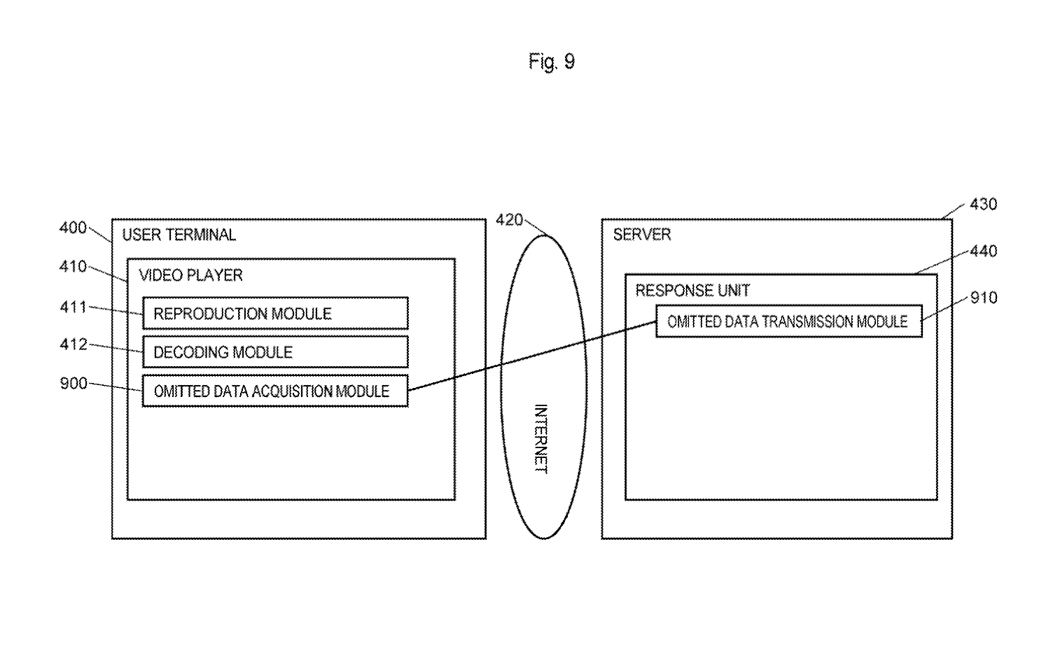

(FIG. 8 and FIG. 9)

Next, FIG. 8 and FIG. 9 are Used to Explain a Specific Example of Reproduction processing of video data in which the data of a specific range has been omitted. In FIG. 8, 800 represents video data from which data in a specific range has been omitted. That is, the video data 800 comprises three types of incomplete data, which are incomplete video data A3, incomplete video data B3, and incomplete video data C3, according to the time t elapsed. 810 to 830 are examples of each of the respective incomplete video data parts A3, B3 and C3. Video data is omitted in a portion of the incomplete video data A3 (810) on the left side, in a portion of the incomplete video data B3 (820) in the center, and in a portion of the incomplete video data C3 (830) on the right side.

FIG. 9 shows a configuration wherein the video player 410 executed by the user terminal 400 reproduces video data from which the data in a specific range has been omitted; the video player 410 comprises the reproduction module 411, decoding module 412, and an omitted data acquisition module 900. The omitted data acquisition module 900 comprised by the video player 410 is a module which realizes the functions of corresponding omitted data acquisition code (not shown), and issues a request, via the Internet 420, for omitted data to an omitted data transmission module 910 comprised by the response unit 440 of the server 430. The omitted data transmission module 910 has an omitted data information table which associates information relating to omitted data with the video player program, and in response to a request from the omitted data acquisition module 900, transmits, to the omitted data acquisition module 900, omitted data information indicating the specific range for the omitted data and the omitted data, in order to enable reproduction of the incomplete video data parts A3, B3 and C3. In this way, the omitted data acquisition module 900 can acquire omitted data information indicating the specific range of the omitted data, and the omitted data, from the omitted data transmission module 910 within the server 430 which functions as the omitted data storage unit.

By means of this configuration, it is made impossible to reproduce the video data comprised by the video player 410 without acquiring omitted data information and omitted data from the server 430, and so there is the advantageous result that the illicit decoding and reproduction by an illicit user of video data comprised by the video player 410 can be prevented.

Authentication or billing can be performed prior to transmission of omitted data information and omitted data to the omitted data acquisition module 900 by the omitted data transmission module 910; in this case, the video player 410 comprises the authentication module 414 or the billing module 415, and the response unit 440 comprises the corresponding authentication response module 442 or billing response module 443. The functions of these modules are as described above.

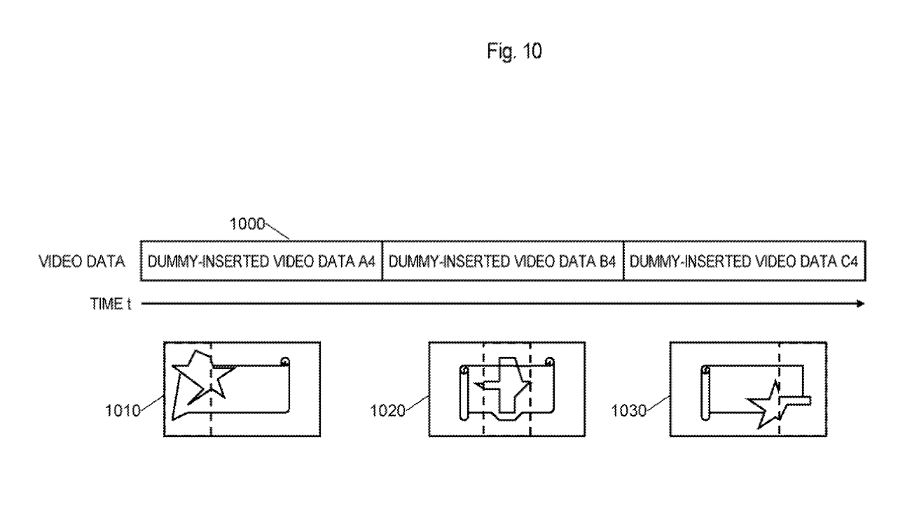

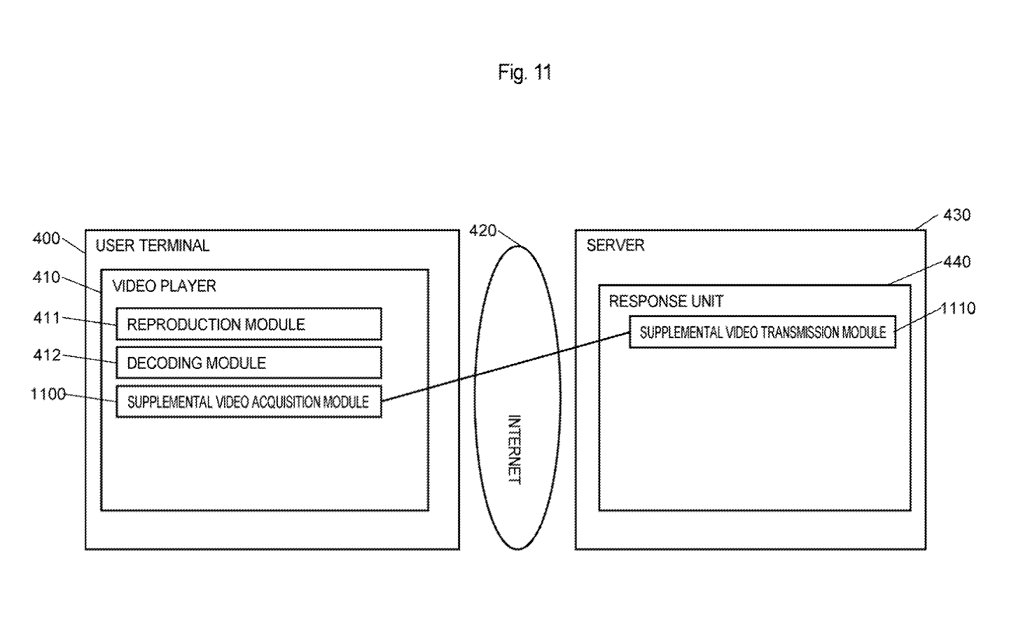

(FIG. 10 and FIG. 11)

Next, FIG. 10 and FIG. 11 are Used to Explain a Specific Example of Processing for reproduction of video data into which dummy data has been inserted in a specific range. In FIG. 10, 1000 represents video data into a specific range of which dummy data has been inserted. That is, the video data 1000 comprises three types of dummy-inserted video data A4, dummy-inserted video data B4, and dummy-inserted video data C4, according to the time t elapsed. 1010 to 1030 are an example of the respective dummy-inserted video data A4, B4 and C4. The dummy data is inserted partially on the left side in the dummy-inserted video data A4 (1010), the dummy data is inserted partially in the center in the dummy-inserted video data B4 (1020), and the dummy data is inserted partially on the right side in the dummy-inserted video data C4 (1030).

FIG. 11 shows a configuration by which the video player 410, executed by the user terminal 400, reproduces video data into which the dummy data has been inserted; the video player 410 comprises the reproduction module 411, decoding module 412, and supplemental video acquisition module 1100. The supplemental video acquisition module 1100 comprised by the video player 410 is a module which realizes the functions of corresponding supplemental video acquisition code (not shown), and issues a request, via the Internet 420, for supplemental data to a supplemental video transmission module 1110 comprised by the response unit 440 of the server 430. The supplemental video transmission module 1110 has a dummy data information table which manages and associates information relating to dummy data information necessary for supplement, and the video player program, and in response to the request from the supplemental video acquisition module 1100, transmits information to reproduce the above-described dummy-inserted video data A4, B4 and C4 to the supplemental video acquisition module 1100. In this way, the supplemental video acquisition module 1100 can acquire dummy data information indicating the specific range for the dummy data, and supplemental video data to interchange with the dummy data, from the supplemental video transmission module 1110 within the server 430 functioning as the supplemental data storage unit.

By means of this configuration, illicit decoding and reproduction of video data included in the video player 410 can be prevented, and at the same time there is the advantageous result that it is made difficult for a person attempting to illicitly analyze the video data to notice that dummy data is inserted into the video.

Authentication or billing processing can be performed prior to transmission of dummy data information and supplemental video data to the supplemental video acquisition module 1100 by the supplemental video transmission module 1110; in this case, the video player 410 comprises the authentication module 414 or the billing module 415, and the response unit 440 comprises the corresponding authentication response module 442 or billing response module 443. The functions of these modules are as described above.

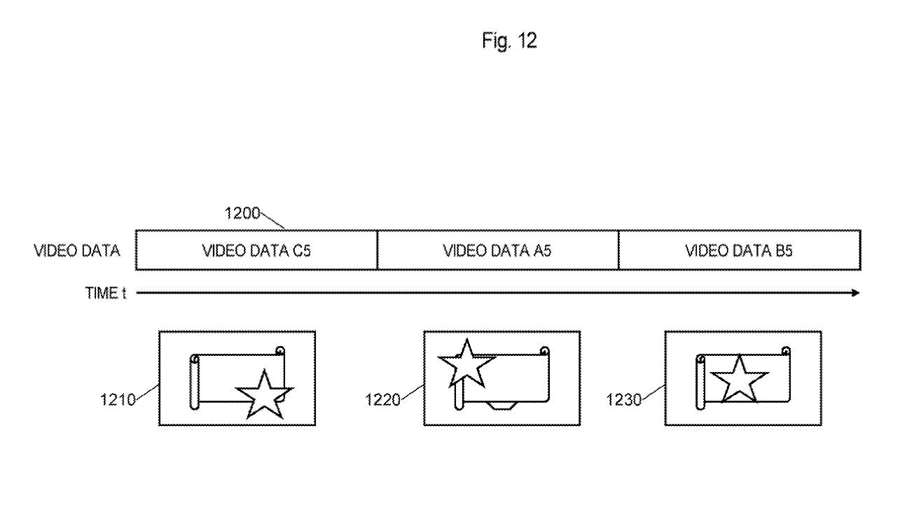

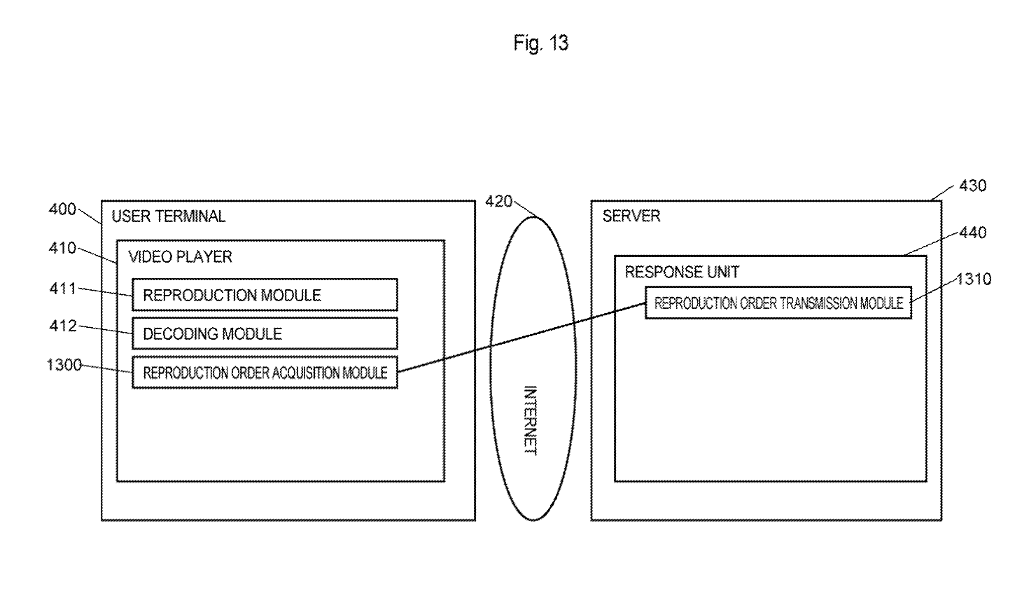

(FIG. 12 and FIG. 13)

Next, FIG. 12 and FIG. 13 are Used to Explain a Specific Example of Processing to reproduce video data in which the reproduction order has been interchanged. In FIG. 12, 1200 represents video data the reproduction order of which has been interchanged. That is, the video data 1200 comprises video data C5, video data A5, and video data B5, according to the time t elapsed. 1210 to 1230 are examples of video data C5, A5 and C5 respectively. Here, despite the fact that the actual video reproduction order is video data A5, B5, C5, in the video data 1200 the reproduction order has been interchanged.

FIG. 13 shows a configuration such that the video player 410 executed by the user terminal 400 reproduces video data the reproduction order of which has been interchanged; the video player 410 comprises the reproduction module 411, decoding module 412, and a reproduction order acquisition module 1300. The reproduction order acquisition module 1300 comprised by the video player 410 is a module which realizes the functions of corresponding reproduction order acquisition code (not shown), and issues a request, via the Internet 420, to a reproduction order transmission module 1310 comprised by the response unit 440 of the server 430 for information indicating the correct reproduction order. The reproduction order transmission module 1310 has a table of information which associates information indicating the correct reproduction order and the video player program, and in response to the request from the reproduction order acquisition module 1330, transmits information indicating the correct reproduction order of the video data C5, A5, B5 to the reproduction order acquisition module 1300. In this way, the reproduction order acquisition module 1300 can acquire, from the reproduction order transmission module 1310 within the server 430 functioning as the reproduction order storage unit, information indicating the correct reproduction order of video data the reproduction order of which has been interchanged.

By means of this configuration, the video data cannot be reproduced in the correct reproduction order without acquiring information indicating the correct reproduction order from the server, and it is possible to impede illicit reproduction of the video data included in the video player 410. In particular, by interchanging the reproduction order in conformance with points (frames) at which scenes change in the video data, it can be made difficult to estimate the reproduction order, so that there is the advantageous result that even if an illicit user were to succeed in extracting the video data, reproduction in the appropriate reproduction order could be prevented.

Authentication or billing processing can be performed prior to transmission by the reproduction order transmission module 1310 to the reproduction order acquisition module 1300 of information indicating the correct reproduction order of video data with the reproduction order interchanged; in this case, the video player 410 comprises the authentication module 414 or the billing module 415, and the response unit 440 comprises the corresponding authentication response module 442 or billing response module 443. The functions of these modules are as described above.

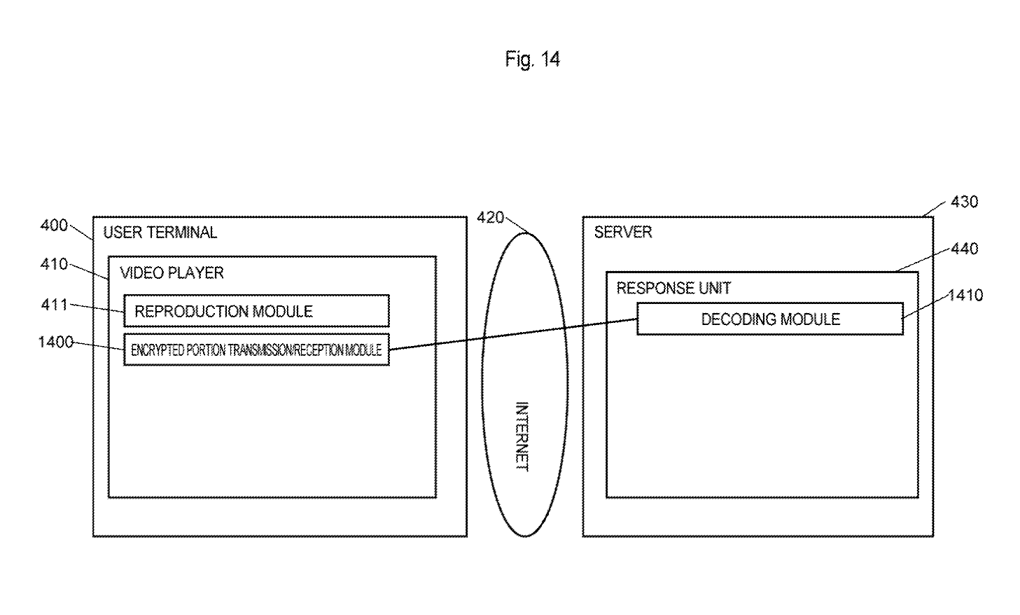

(FIG. 14)

Next, FIG. 14 is used to explain a specific example of a case in which, for video data which has been encrypted only in a specific range, the encrypted portion is decoded by the video decoding unit. FIG. 14 shows a configuration wherein the video player 410 executed by the user terminal 400 reproduces video data which has been encrypted only in a specific range of specific frames; the video player 410 comprises the reproduction module 411 and an encrypted portion transmission/reception module 1400. The encrypted portion transmission/reception module 1400 comprised by the video player 410 is a module which realizes the functions of corresponding encrypted portion transmission/reception code (not shown), and transmits, via the Internet 420, the encrypted portion of the encrypted video data to a decoding module 1410, comprised by the response unit 440 of the server 430, which functions as a video decoding unit. The decoding module 1410 has a decoding information table which presents information to decode received video data, and references this decoding information table to decode received encrypted video data, and transmits the result to the encrypted portion transmission/reception module 1400. In this way the encrypted portion transmission/reception module 1400 can transmit the encrypted portion of encrypted video data to the decoding module 1410 within the server 430 functioning as the video decoding unit, and can receive the decoded video data.

By means of this configuration, because a decoding algorithm is not stored in the video player, it is difficult to analyze encryption and decoding algorithms and to illicitly acquire a decryption key, and so there is the advantageous result that illicit reproduction of video data can be prevented. Further, by limiting the encrypted portion to a specific range, there is the advantageous result that the decoding load on the server can be alleviated.

Authentication or billing processing can be performed prior to decoding of an encrypted portion of received video data by the decoding module 1410; in this case, the video player 410 comprises the authentication module 414 or the billing module 415, and the response unit 440 comprises the corresponding authentication response module 442 or billing response module 443. The functions of these modules are as described above.

### Modified Example

This invention is not limited to the above-described embodiments, but can be variously modified and applied, and at least each of the modules, code parts, encryption methods and similar explained in the embodiments can be combined and applied, insofar as contradictions do not occur. For example, a video player 410 of a user terminal 400 comprising the reproduction module 411, decoding module 412 and reproduction order acquisition module 1300 shown in FIG. 13 can further comprise the video transmission module 418 shown in FIG. 5, and a configuration can be employed in which an external device is used for reproduction at the time of video reproduction.
100 Video reproduction code generation device
110 Data acquisition unit
120 Video data storage unit
130 Code acquisition unit
140 Video reproduction template code storage unit
150 Code generation unit
160 Execution file generation unit
170 Delivery unit
200 Video reproduction template code
210 Video reproduction code
211a Reproduction template code
211b Reproduction code
212 Decoding code
213 Decryption key acquisition code
214 Authentication code
215 Billing code
216 Distributor information transmission code
217 Self-delivery code
218 Video transmission code
220 Video data
221 Data part 1
222 Data part 2
400 User terminal
410 Video player
411 Reproduction module
412 Decoding module
413 Decryption key acquisition module
414 Authentication module
415 Billing module
416 Distributor information transmission module
420 Internet
430 Server
440 Response unit
441 Decryption key response module
442 Authentication response module
443 Billing response module
444 Distributor information management module
450 External device
600 Decoding information transmission module
900 Omitted data acquisition module
910 Omitted data transmission module
1100 Supplemental video acquisition module
1110 Supplemental video transmission module
1300 Reproduction order acquisition module
1310 Reproduction order transmission module
1400 Encrypted portion transmission/reception module
1410 Decoding module

1-19. (canceled)

20. A video reproduction code generation device, comprising:
a data acquisition unit which acquires video data;
a code acquisition unit which acquires video reproduction template code configured to enable reproduction of video data stored in a variable in code; and
a code generation unit, which divides the acquired video data into two or more data parts, embeds the data parts into the acquired video reproduction template code as variable values of different variables, and generates dedicated video reproduction code for the acquired video data, wherein
the video data is encrypted only in a specific range of a specific frame of the video; and
the video reproduction template code has:
decoding code which references the variable and acquires the encrypted video data, acquires, from a decoding information storage unit, decoding information including a specific frame and specific range information for decoding the encrypted video data, and decodes the acquired encrypted video data; and
reproduction code which reproduces the decoded video data.

21. The video reproduction code generation device according to claim 20, wherein the encrypted video data requires a decryption key for decoding, and the video reproduction template code further has decryption key acquisition code which acquires a decryption key, which is used in decoding the encrypted video data, from a decryption key storage unit.

22. The video reproduction code generation device according to claim 20, wherein the video reproduction template code further has authentication code which transmits an authentication request to an authentication response unit, and receives an authentication result.

23. The video reproduction code generation device according to claim 22, wherein the video reproduction template code further has billing code which performs fee payment processing to a billing response unit for authentication.

24. The video reproduction code generation device according to claim 20, wherein the video reproduction template code further has distributor information transmission code, which transmits distributor information specifying a distributor of the video data to a distributor information management unit.

25. A video delivery system, comprising:
the video reproduction code generation device according to claim 20;
an execution file generation unit which compiles the generated video reproduction code and generates an execution file; and
a delivery unit which delivers the created execution file to a user terminal via a communication network.

26. A video reproduction code generation device, comprising:
a data acquisition unit which acquires video data;
a code acquisition unit which acquires video reproduction template code configured to enable reproduction of video data stored in a variable in code; and
a code generation unit, which divides the acquired video data into two or more data parts, embeds the data parts into the acquired video reproduction template code as variable values of different variables, and generates dedicated video reproduction code for the acquired video data, wherein
data in a specific range of the video is omitted from the video data; and
the video reproduction template code includes omitted data acquisition code which acquires from an omitted data storage unit, omitted data information indicating the specific range of the omitted data, and omitted data.

27. The video reproduction code generation device according to claim 26, wherein
the video data stored in the variable is encrypted video data, and
the video reproduction template code has decoding code which acquires encrypted video data in reference to the variable and decodes the acquired encrypted video data, and reproduction code which reproduces the decoded video data.

28. The video reproduction code generation device according to claim 26, wherein the encrypted video data requires a decryption key for decoding, and the video reproduction template code further has decryption key acquisition code which acquires a decryption key, which is used in decoding the encrypted video data, from a decryption key storage unit.

29. The video reproduction code generation device according to claim 26, wherein the video reproduction template code further has authentication code which transmits an authentication request to an authentication response unit, and receives an authentication result.

30. The video reproduction code generation device according to claim 29, wherein the video reproduction template code further has billing code which performs fee payment processing to a billing response unit for authentication.

31. The video reproduction code generation device according to claim 26, wherein the video reproduction template code further has distributor information transmission code, which transmits distributor information specifying a distributor of the video data to a distributor information management unit.

32. A video delivery system, comprising:
the video reproduction code generation device according to claim 26;
an execution file generation unit which compiles the generated video reproduction code and generates an execution file; and
a delivery unit which delivers the created execution file to a user terminal via a communication network.

33. A video reproduction code generation device, comprising:
a data acquisition unit which acquires video data;
a code acquisition unit which acquires video reproduction template code configured to enable reproduction of video data stored in a variable in code; and
a code generation unit, which divides the acquired video data into two or more data parts, embeds the data parts into the acquired video reproduction template code as variable values of different variables, and generates dedicated video reproduction code for the acquired video data, wherein
the video data has dummy data inserted into a specific range of the video; and
the video reproduction template code includes supplemental video acquisition code which acquires, from a supplemental data storage unit, dummy data information indicating the specific range of the dummy data, and supplemental video data to be interchanged with the dummy data.

34. The video reproduction code generation device according to claim 33, wherein
the video data stored in the variable is encrypted video data, and
the video reproduction template code has decoding code which acquires encrypted video data in reference to the variable and decodes the acquired encrypted video data, and reproduction code which reproduces the decoded video data.

35. The video reproduction code generation device according to claim 33, wherein the encrypted video data requires a decryption key for decoding, and the video reproduction template code further has decryption key acquisition code which acquires a decryption key, which is used in decoding the encrypted video data, from a decryption key storage unit.

36. The video reproduction code generation device according to claim 33, wherein the video reproduction template code further has authentication code which transmits an authentication request to an authentication response unit, and receives an authentication result.

37. The video reproduction code generation device according to claim 36, wherein the video reproduction template code further has billing code which performs fee payment processing to a billing response unit for authentication.

38. The video reproduction code generation device according to claim 33, wherein the video reproduction template code further has distributor information transmission code, which transmits distributor information specifying a distributor of the video data to a distributor information management unit.

39. A video delivery system, comprising:
the video reproduction code generation device according to claim 33;
an execution file generation unit which compiles the generated video reproduction code and generates an execution file; and
a delivery unit which delivers the created execution file to a user terminal via a communication network.

40. A video reproduction code generation device, comprising:
a data acquisition unit which acquires video data;
a code acquisition unit which acquires video reproduction template code configured to enable reproduction of video data stored in a variable in code; and
a code generation unit, which divides the acquired video data into two or more data parts, embeds the data parts into the acquired video reproduction template code as variable values of different variables, and generates dedicated video reproduction code for the acquired video data, wherein
reproduction order for the acquired video data is interchanged; and
the video reproduction template code has reproduction order acquisition code which acquires, from a reproduction order storage unit, information indicating the correct reproduction order of the video data the reproduction order of which has been interchanged.

41. The video reproduction code generation device according to claim 40, wherein
the video data stored in the variable is encrypted video data, and
the video reproduction template code has decoding code which acquires encrypted video data in reference to the variable and decodes the acquired encrypted video data, and reproduction code which reproduces the decoded video data.

42. The video reproduction code generation device according to claim 40, wherein the encrypted video data requires a decryption key for decoding, and the video reproduction template code further has decryption key acquisition code which acquires a decryption key, which is used in decoding the encrypted video data, from a decryption key storage unit.

43. The video reproduction code generation device according to claim 40, wherein the video reproduction template code further has authentication code which transmits an authentication request to an authentication response unit, and receives an authentication result.

44. The video reproduction code generation device according to claim 43, wherein the video reproduction template code further has billing code which performs fee payment processing to a billing response unit for authentication.

45. The video reproduction code generation device according to claim 40, wherein the video reproduction template code further has distributor information transmission code, which transmits distributor information specifying a distributor of the video data to a distributor information management unit.

46. A video delivery system, comprising:
the video reproduction code generation device according to claim 40;
an execution file generation unit which compiles the generated video reproduction code and generates an execution file; and
a delivery unit which delivers the created execution file to a user terminal via a communication network.

47. A video reproduction code generation device, comprising:
a data acquisition unit which acquires video data;
a code acquisition unit which acquires video reproduction template code configured to enable reproduction of video data stored in a variable in code; and
a code generation unit, which divides the acquired video data into two or more data parts, embeds the data parts into the acquired video reproduction template code as variable values of different variables, and generates dedicated video reproduction code for the acquired video data, wherein
the video data is encrypted only in a specific range of video; and
the video reproduction template code has encrypted portion transmission/reception code which transmits the encrypted portion of the encrypted video data to a video decoding unit, and receives decoded video data.

48. The video reproduction code generation device according to claim 47, wherein the encrypted video data requires a decryption key for decoding, and the video reproduction template code further has decryption key acquisition code which acquires a decryption key, which is used in decoding the encrypted video data, from a decryption key storage unit.

49. The video reproduction code generation device according to claim 47, wherein the video reproduction template code further has authentication code which transmits an authentication request to an authentication response unit, and receives an authentication result.

50. The video reproduction code generation device according to claim 49, wherein the video reproduction template code further has billing code which performs fee payment processing to a billing response unit for authentication.

51. The video reproduction code generation device according to claim 47, wherein the video reproduction template code further has distributor information transmission code, which transmits distributor information specifying a distributor of the video data to a distributor information management unit.

52. A video delivery system, comprising:
the video reproduction code generation device according to claim 47;
an execution file generation unit which compiles the generated video reproduction code and generates an execution file; and
a delivery unit which delivers the created execution file to a user terminal via a communication network.

53. A computer program product comprising non-transitory computer-readable medium having computer program logic recorded thereon that, when executed by one or more processors, allows for the reproduction of specific video data stored in a variable, wherein
data parts obtained by dividing the specific video data into two or more parts, are held as variable values of different variables, and
the video data is encrypted only in a specific range of a specific frame of the video,
the computer program logic comprising:
a decoding module function for referencing the variable and acquiring the encrypted video data, acquiring from a decoded information storage unit, decoding information including the specific frame and specific range information for decoding the encrypted video data, and decoding the acquired encrypted video data; and
a reproduction module function for reproducing the decoded video data.

54. A computer program product comprising non-transitory computer-readable medium having computer program logic recorded thereon that, when executed by one or more processors, allows for the reproduction of specific video data stored in a variable, wherein
data parts obtained by dividing the specific video data into two or more parts, are held as variable values of different variables, and
data in a specific range of the video is omitted from the video data,
the computer program logic comprising:
an omitted data acquisition module function for acquiring, from an omitted data storage unit, omitted data information indicating the specific range for the omitted data, and the omitted data, is provided.

55. A computer program product comprising non-transitory computer-readable medium having computer program logic recorded thereon that, when executed by one or more processors, allows for the reproduction of specific video data stored in a variable, wherein
data parts obtained by dividing the specific video data into two or more parts, are held as variable values of different variables, and
the video data has dummy data inserted in a specific range of the video,
the computer program logic comprising:
a supplemental video acquisition module function for acquiring, from a supplemental data storage unit, dummy data information indicating the specific range for the dummy data, and supplemental data to be interchanged with the dummy data.

56. A computer program product comprising non-transitory computer-readable medium having computer program logic recorded thereon that, when executed by one or more processors, allows for the reproduction of specific video data stored in a variable, wherein
data parts obtained by dividing the specific video data into two or more parts, are held as variable values of different variables, and
reproduction order for the acquired video data is interchanged,
the computer program logic comprising:
a reproduction order acquisition module function, which acquires, from a reproduction order storage unit, information indicating the correct reproduction order of the video data the reproduction order of which has been interchanged.

57. A computer program product comprising non-transitory computer-readable medium having computer program logic recorded thereon that, when executed by one or more processors, allows for the reproduction of specific video data stored in a variable, wherein
data parts obtained by dividing the specific video data into two or more parts, are held as variable values of different variables, and
the video data is encrypted only in a specific range of the video,
the computer program logic comprising:
an encrypted portion transmission/reception module function for transmitting the encrypted portion of the encrypted video data to a video decoding unit, and for receiving decoded video data.

58. A server for supporting reproduction of video data encrypted only in a specific range of a specific frame of the video, comprising:
a decoding information transmission module having a decoding information table which manages decoding information necessary to perform decoding of the encrypted video data, wherein
the decoding information transmission module transmits the decoding information to a terminal which is attempting to reproduce the encrypted video data, in response to a request from the terminal, and
the decoding information includes a specific frame and specific range information for decoding the encrypted video data.

59. A server for supporting reproduction of video data in which data in a specific range of the video is omitted, comprising:
an omitted data transmission module having an omitted data information table which manages information relating to omitted data, wherein
the omitted data transmission module, in response to a request from a terminal which is attempting to reproduce the video data, transmits to the terminal omitted data information indicating the specific range for the omitted data, and the omitted data, for reproducing the video data.

60. A server for supporting reproduction of video data into which dummy data has been inserted in a specific range of the video, comprising:
a supplemental video transmission module having a dummy data information table which manages information related to dummy data information necessary to supplement the video data, wherein
the supplemental video transmission module, in response to a request from a terminal which is attempting to reproduce the video data, transmits to the terminal dummy data information indicating the specific range for the dummy data, and supplemental video data to be interchanged with the dummy data.

61. A server for supporting reproduction of video data the reproduction order of which has been interchanged, comprising:
a reproduction order transmission module having a table indicating the correct reproduction order of the video data, wherein
the reproduction order transmission module, in response to a request from a terminal which is attempting to reproduce the video data, transmits to the terminal information indicating the correct reproduction order of the video data.

62. A server for supporting reproduction of video data which has been encrypted only in a specific range of the video, comprising:
a decoding module having a decoding information table which indicates information used to decode received video data, wherein
the decoding module references the decoding information table, decodes the video data received from a terminal which is attempting to reproduce the video data, and transmits this data to the terminal.

63. A video reproduction code generation method, comprising:
a data acquisition step of acquiring video data;
a code acquisition step of acquiring video reproduction template code configured to enable reproduction of video data stored in a variable in the code; and
a code generation step of dividing the acquired video data into two or more data parts, and embedding the data parts into the acquired video reproduction template code as variable values of different variables, thereby generating dedicated video reproduction code for the acquired video data, wherein
the video data stored in the variable is encrypted only in a specific range of a specific frame of the video, and
the video reproduction template code has:
decoding code which references the variable and acquires the encrypted video data, acquires, from a decoding information storage unit, decoding information including a specific frame and specific range information for decoding the encrypted video data, and decodes the acquired encrypted video data; and
reproduction code which reproduces the decoded video data.

64. A video reproduction code generation method, comprising:
a data acquisition step of acquiring video data;
a code acquisition step of acquiring video reproduction template code configured to enable reproduction of video data stored in a variable in the code; and
a code generation step of dividing the acquired video data into two or more data parts, and embedding the data parts into the acquired video reproduction template code as variable values of different variables, thereby generating dedicated video reproduction code for the acquired video data, wherein
data in a specific range of the video is omitted from the video data, and
the video reproduction template code includes omitted data acquisition code which acquires, from an omitted data storage unit, omitted data information indicating the specific range for the omitted data, and omitted data.

65. A video reproduction code generation method, comprising:
a data acquisition step of acquiring video data;
a code acquisition step of acquiring video reproduction template code configured to enable reproduction of video data stored in a variable in the code; and
a code generation step of dividing the acquired video data into two or more data parts, and embedding the data parts into the acquired video reproduction template code as variable values of different variables, thereby generating dedicated video reproduction code for the acquired video data, wherein
the video data has dummy data inserted in a specific range of the video;
and the video reproduction template code has supplemental video acquisition code which acquires, from a supplemental data storage unit, dummy data information indicating the specific range for the dummy data, and supplemental video data to be interchanged with dummy data.

66. A video reproduction code generation method, comprising:
a data acquisition step of acquiring video data;
a code acquisition step of acquiring video reproduction template code configured to enable reproduction of video data stored in a variable in the code; and
a code generation step of dividing the acquired video data into two or more data parts, and embedding the data parts into the acquired video reproduction template code as variable values of different variables, thereby generating dedicated video reproduction code for the acquired video data, wherein
reproduction order of the acquired video data is interchanged, and
the video reproduction template code has reproduction order acquisition code which acquires, from a reproduction order storage unit, information indicating the correct reproduction order of the video data the reproduction order of which has been interchanged.

67. A video reproduction code generation method, comprising:
a data acquisition step of acquiring video data;
a code acquisition step of acquiring video reproduction template code configured to enable reproduction of video data stored in a variable in the code; and
a code generation step of dividing the acquired video data into two or more data parts, and embedding the data parts into the acquired video reproduction template code as variable values of different variables, thereby generating dedicated video reproduction code for the acquired video data, wherein
the video data is encrypted only in a specific range of the video; and
the video reproduction template code has encrypted portion transmission/reception code which transmits the encrypted portion of the encrypted video data to a video decoding unit, and which receives decoded video data.
